(19) United States
(12) Patent Application Publication
(10) Pub. No.: US 2011/0044936 A1
(43) Pub. Date: Feb. 24, 2011

(54) Composition for Attracting Bed Bugs

(76) Inventors: Bruce C. Black, Yardley, PA (US); Shreya J. Shah, Lawrenceville, NJ (US); Linda Varanyak, Mercerville, NJ (US); Frank J. Zawacki, Yardley, PA (US)

Correspondence Address: PATENT ADMINISTRATOR;FMC CORPORATION, 1735 MARKET STREET, PHILADELPHIA, PA, 19103, US

(21) Appl. No.: 12/811,526

(22) PCT Filed: Mar. 11, 2010
(86) PCT No.: PCT/US10/26938

§ 371 Date: Jul. 2, 2010

Related U.S. Application Data
(60) Provisional application No. 61/210,106, filed on Mar. 13, 2009.

(51) Int. Cl. A01N 31/00

(52) U.S. Cl. 424/84

(57) ABSTRACT

The present invention provides a composition comprising an unsaturated aldehyde component and an organic acid component which is a powerful bed bug attractant when volatilized and released at very low concentrations. This attractant can be used to lure bed bugs to a location in which the bed bugs can be detected, monitored and/or trapped.

This application claims the benefit of U.S. Provisional Application No. 61/210,106 filed Mar. 13, 2009.

### FIELD OF THE INVENTION

This invention relates to chemical attractants for bed bugs. In particular, these chemical attractants can be associated with devices for the detection, monitoring or trapping bed bug populations.

### BACKGROUND OF THE INVENTION

Blood feeding insects such as bed bugs are nuisance pests that afflict humans, pets and domestic animals. Because of their cryptic behavior, the detection and control of the common bed bugs, Cimex lectularius and Cimex hemipterous, is often very difficult and time consuming.

The common bed bug is the species of bed bug that has most adapted to living with humans. Bed bugs have lived with humans since ancient times, although many people living in the United States have never seen a bed bug. However, the increase of international travel in recent decades has contributed to the resurgence of bed bugs in the United States. There are many aspects of bed bugs that make it difficult to eradicate them once they have established a presence in a location.

Adult bed bugs are about 6 millimeters long, 5 to 6 millimeters wide, and reddish-brown with oval, flattened bodies. The immature nymphs are similar in appearance to the adults but smaller and lighter in color. Bed bugs do not fly, but they can move quickly over surfaces. Female bed bugs lay their eggs in secluded areas and can deposit up to five eggs per day, and as many as 500 during a lifetime. The bed bug eggs are very small, about the size of a dust spec. When first laid, the eggs are sticky causing them to adhere to surfaces.

Bed bugs can go long periods of time without feeding. Nymphs can survive months without feeding and the adults for up to a year. Infestations are therefore not likely to be eliminated by leaving a location unoccupied for brief periods of time.

Bed bugs are active during the nighttime and primarily hide during the daytime in tiny crevices or cracks. Bed bugs may find easy hiding places in beds, bed frames, furniture, along baseboards, in carpeting, and countless other places. Bed bugs tend to congregate but do not build nests like some other insects.

Bed bugs obtain their sustenance by drawing blood through elongated mouth parts. They may feed on a human for 3 to 10 minutes although the person is not likely to feel the bite. After the bite, the victim often experiences an itchy welt or a delayed hypersensitivity reaction resulting in a swelling in the area of the bite. However, some people do not have any reaction or only a very small reaction to a bed bug bite. Bed bug bites have symptoms that are similar to other insect bites, such as mosquitoes and ticks. It is not possible to determine whether a bite is from a bed bug, another type of insect or could even be misdiagnosed as hives or a skin rash and the like, without actually observing the bed bug. As a result, bed bug infestations frequently go long periods without being detected.

Bed bug infestations originate by a bed bug being carried into a new area. Bed bugs are able to cling to possessions and hide in small spaces so that they may easily be transported in a traveler's belongings. As a result, buildings where turnover of occupants is high, such as hotels, dormitories and apartments, are especially vulnerable to bed bug infestations.

Because of all the features of bed bugs described herein, bed bugs are both difficult to detect and to eradicate. Professional pest removal specialists and pesticides are needed. It is necessary to remove all clutter and unnecessary objects from a room, remove bed bugs and eggs as much as possible through vacuuming, and apply pesticides to likely hiding areas. This type of treatment for eradication can be disruptive to a business such as a hotel. As a result, it is very desirable to detect bed bugs at the earliest possible moment before an infestation becomes established.

The tiny, mobile and secretive behavior of bed bugs makes it nearly impossible to prevent an infestation. Bed bugs have been found to move through holes in walls, ceilings and floors into adjacent rooms. For this reason, the earliest detection can make it possible to eradicate the insects most easily as well as preventing their dissemination. Devices and methods for the early detection of bed bugs are needed especially by those in the hospitality industries.

Bed bug monitors and traps have been used to detect the presence of these insects with varied reports of success and are generally very expensive and not deemed effective. Glue traps and double-sided carpet tape must be placed in strategic areas in order for the insects to become trapped for later identification. Commercial monitor traps must be able to attract the insects into the trap for later identification. Such traps and attractants must remain undisturbed for periods of time in order to be effective and often depend on the extent of the infestation. The need for monitor traps is most important after professional bed bug treatments to insure the success of the pesticidal application.

U.S. Patent Application 2008/0168703 A1, published Jul. 17, 2008, discloses a chemical formulation which is capable of attracting bed bugs when volatized wherein the formulation contains a complex mixture of two monoterpenes, two saturated aldehydes, three unsaturated aldehydes, one aromatic aldehyde, one aromatic alcohol and a ketone.

An international application published May 2, 2008 under the Patent Cooperation Treaty, WO 2008/051501 A2, discloses bed bug detection, monitoring and control techniques which include attractants to lure bed bugs to a location in which the attractants include any combination of one or more of avian or mammalian pheromones, hormones, sweat, epidermic oils, choline and other body odors.

An international application published Mar. 8, 2007 under the Patent Cooperation Treaty, WO 2007/027601 A2, discloses components of breath, perspiration and hair or skin oil as bed bug olfactory attractants.

It would be most beneficial to provide a simple, inexpensive, and highly effective bed bug attractant composition in order to efficiently lure bed bugs to a location of a bed bug detector, monitor and/or trap.

### SUMMARY OF THE INVENTION

It has been discovered that a chemical composition comprising an unsaturated aldehyde component and an organic acid component is a powerful bed bug attractant when volatilized and released at very low concentrations. This composition can be used to attract bed bugs to a location in which the bed bugs can be detected, monitored and/or trapped.

### DETAILED DESCRIPTION OF THE INVENTION

The present invention provides a chemical bed bug (Cimex lectularius and Cimex hemipterous) attractant composition and method of using the composition to attract bed bugs to a location where the bed bugs can be detected, monitored and/or trapped. The attractant composition, comprising an unsaturated aldehyde component and an organic acid component, can be volatized either by exposure to ambient temperatures, by warming the composition, by air movement or a combination thereof. Compared to complicated mixtures of expensive chemicals that are disclosed in the literature to attract bed bugs, the present invention provides a very simple, safe, easy to use and inexpensive chemical bed bug attractant composition.

In one aspect of the present invention there is provided a bed bug attractant composition comprising an unsaturated aldehyde component and an organic acid component.

In another aspect of the present invention there is provided a bed bug attractant composition consisting essentially of an unsaturated aldehyde component and an organic acid component.

In one aspect of the present invention the unsaturated aldehyde component can be comprised of one or more aldehydes selected from the group consisting of trans-2-hexen-1-al (Hexenal) and trans-2-octen-1-al (Octenal). It is preferred that the organic acid component is butyric acid. In addition, pro-aldehyde compounds and pro-organic acid compounds, that is, compounds that chemically degrade when exposed to air or moisture to the desired aldehyde or organic acid can be employed. For example, trans-2-hexen-1-al diethylacetal and trans-2-octen-1-al diethylacetal can be used in place of Hexenal or Octenal and trimethylsilyl butyrate, methyl butyrate or ethyl butyrate can be used in place of butyric acid.

Another aspect of the present invention provides a method for attracting bed bugs to a desired location comprising locating an attractant composition comprising:

an unsaturated aldehyde component and

an organic acid component, in the desired location.

Another aspect of the present invention provides a method for attracting bed bugs to a desired location comprising locating an attractant composition consisting essentially of:

an unsaturated aldehyde component and

an organic acid component, in the desired location.

The location can be in, on or near a bed bug control device which is located in one or more rooms of homes, hotels, motels, inns, barracks, cruise ships, shelters, nursing homes, camp dwellings, dormitories, condominiums, apartments, dwellings with human or animal habitation and the like, in which bed bugs were present, are present or are expected to be present. Suitable bed bug control devices include monitors, traps, baiting stations and indicator stations.

When the aldehyde component is comprised of both Hexenal and Octenal, it is preferred that the aldehydes be present in a weight to weight ratio of from about 1:5 to about 5:1 of Hexenal to Octenal, more preferably in a ratio of between about 3:1 to about 1:3.

In order to be most attractive to bed bugs, the optimal concentration of the aldehyde component to be released is from about 2 ng/hr to about 4500 ng/hour, preferably from about 33 ng/hr to about 810 ng/hour, most preferred about 390 ng/hr. The optimal concentration of organic acid to be released is from about 0.12 ng/hr to about 120000 ng/hr, preferably from about 1.2 ng/hr to about 1500 ng/L/hr, most preferred about 120 ng/hr.

Mixing butyric acid with Hexenal and/or Octenal forms an unstable composition and it is necessary to separate the aldehyde component from the acid component. In order for the separate components of the attractant composition to be released at the proper rates, each component may be incorporated into a separate formulation which can be in gel form, a solid form, dissolved in a polar solvent such as water, dissolved in an oil such as silicon oil, dissolved in any suitable organic solvent, a particularly preferred organic solvent includes, for example, a C₈-C₁₂ alkane, encapsulated, or impregnated into other materials, for example, rubber septa or waxes. Each component may be incorporated into an absorbent material, for example, but not limited to cotton batting, fiberized cellulose wood pulp, synthetic batting, polyester batting, felt, bonded carded webs, very high density polyethylene sponge and high loft spunbond materials. In order to regulate diffusion, a semi-permeable membrane can be used to encase the absorbent materials. The attractant components can be dispensed from containers with either a semi-permeable top or a sealed top containing one or more holes to allow diffusion into the surrounding atmosphere.

The aldehyde component and the organic acid component can further comprise a preservative, for example triacetin, vitamin E, or butylated hydroxytoluene (BHT) and the like.

An alternative preferred embodiment involves the use of Octenal or Hexenal alone; with or without the use of butyric acid as a co-attractant.

The aldehydes and organic acids of the present invention are heavier than air and, for this reason; an aid in the volatization of these chemicals may be advantageous. Volatization of the composition can be by simple evaporation of the composition, or formulation thereof, at ambient temperatures or by warming using a heat source. Heat can be provided in a number of ways such as through a chemical reaction, a coil resistance heater, an electric bulb, a light emitting diode, a transistor and the like. It is preferred that the heat source provide a temperature in a range of from about 30° C. to about 40° C., most preferred in a range of from about 32° C. to about 35° C. In addition, a micro fan, a piezoelectric nebulizer or passive ventilation can be used.

It has also been found that the addition of carbon dioxide to the volatilized composition provides an improvement in attractant performance A carbon dioxide level between about 1% and about 50%, by volume, of the atmosphere of the volatized composition is preferred.

In a preferred embodiment of the present invention, there is provided a method of attracting bed bugs to a location by volatilizing a bed bug attractant composition comprising an unsaturated aldehyde component and an organic acid component optionally adding carbon dioxide and/or heat to the volatilized composition.

The following examples further illustrate the present invention and include protocols for the evaluation of the method of the present invention but, of course, should not be construed as in any way limiting its scope.

### Example 1

### Determination of Bed Bug Aggregation Effect

Attraction Assays: Assay arenas were made from 150×15 mm plastic Petri dishes (VWR#25384-326) containing a 125 mm piece off qualitative filter paper (VWR#28320-100) glued to the bottom using 3M Super 77® multipurpose spray adhesive. A 80 mm hole was cut into the lid and a 500 um mesh Nytex® screen (Bioquip, #7293B) was glued to cover the opening using quick epoxy. Fresh bottom dishes were used in each assay. For these experiments 2.4 cm filter paper folded to create a tent were treated with either a control treatment (10 microliters of silicone oil for aldehyde controls and 5 microliters of deionized water for acid controls) or 10 microliters of the experimental test treatment diluted in silicone oil (aldehydes) or 5 microliters of the experimental chemical diluted in deionized water (acids). Ten bed bugs per test were released into the assay arena for the aldehyde test treatments and controls, five bed bugs per test were released into the assay arena for the acid test treatments. Day cycling bed bugs (Cimex lectularius), 12 hour light: 12 hour dark (7 AM On: 7 PM Off) light cycle, were incubated and evaluated under normal room lighting conditions at room temperature. Readings were taken at 1 hour intervals from the release of bed bugs for 4 hours for aldehydes and one hour for acids, due to the quick volatility of the acids. The number of bed bugs under the control filter paper disk and the number of bed bugs under the test treatment filter paper disk were recorded. The test treatment was considered to be an attractant if the number of bed bugs under the experimental filter disk was greater than the number under the control filter disk. Table 1 below summarizes the experimental data, the experimental test treatments considered as attractants are in bold.

TABLE 1
Bed Bug Attraction to Aldehydes and Organic Acids

| Treatment Rate | 1 Hour | | 2 Hour | | 3 Hour | | 4 Hour | |
|---|---|---|---|---|---|---|---|---|
| *(ppm) | Control | Exp | Control | Exp | Control | Exp | Control | Exp |

Table 1A Aldehydes

| | | | | | | | | |
|---|---|---|---|---|---|---|---|---|
| Hexenal | | | | | | | | |
| *10000 | 3 | 0 | 4 | 1 | 4 | 1 | 4 | 1 |
| 1000 | 1 | 6 | 1 | 7 | 1 | 9 | 1 | 9 |
| 100 | 0 | 6.5 | 0 | 8 | 0 | 9 | 0 | 8.5 |
| 10 | 9 | 3 | 5 | 3.5 | 5 | 4 | 5 | 5.5 |
| 1 | 0 | 4 | 0 | 6 | 0 | 6.5 | 0.5 | 6 |
| Octenal | | | | | | | | |
| *10000 | 0 | 2 | 2 | 2 | 3 | 2 | 4 | 4 |
| 1000 | 1.5 | 5 | 3 | 4.5 | 3 | 5 | 3 | 5 |
| 100 | 0 | 5 | 1 | 6.5 | 1 | 7 | 1 | 6.5 |
| 10 | 4 | 2 | 4.5 | 4 | 5 | 4.5 | 5.5 | 4 |
| 1 | 5 | 1 | 4.5 | 2 | 5.5 | 3.5 | 3.5 | 5 |
| **Valeraldehyde | | | | | | | | |
| 10 milligrams | 0.3 | 0.1 | ND | ND | ND | ND | ND | ND |

Table 1B Organic Acids

| | | |
|---|---|---|
| Formic acid | | |
| 1000 | 1 | 3 |
| 100 | 4 | 1 |
| 50 | 3 | 1 |
| 10 | 3 | 0 |
| Acetic acid | | |
| 10000 | 3 | 3 |
| 1000 | 2 | 3 |
| 100 | 1 | 1 |
| 50 | 2 | 1 |
| 10 | 1 | 0 |
| Butyric acid | | |
| 10000 | 1 | 4 |
| 1000 | 0 | 4 |
| 100 | 0 | 4 |
| 50 | 2 | 2 |
| 10 | 0 | 4 |

*10000 ppm rate for Hexenal and Octenal was one test; all others were an average of two tests.
Hexenal is trans-hex-2-en-1-al
Octenal is trans-oct-2-en-1-al
“Exp” is experimental test treatment
**Average of two tests. These tests had 6 control filter paper disks treated with 10 microliters of methanol and one experimental filter paper disk treated with 10 microliters of a valeraldehyde/methanol solution which delivered 10 milligrams of valeraldehyde to the filter paper; test reading was at one hour only.

Using the aggregation assay as described above, the most bed bugs were attracted with Hexenal between about 1 and about 1,000 ppm or with Octenal between about 100 and about 1000 ppm. At a high concentration of about 10,000 ppm, Hexenal and Octenal were much less attractive to bed bugs. Octenal at concentrations below about 100 ppm also were less attractive to bed bugs. Of the organic acids tested, butyric acid at about 10 to about 10,000 ppm was the most attractive to bed bugs. Valeraldehyde, a saturated aldehyde, was not attractive to bed bugs in this test.

### Example 2

### Determination of Bed Bug Aggregation Effect Using Mixtures of Hexenal and Octenal

Attraction Assays: In a manner similar to that described in Example 1, ten bed bugs (Cimex lectularius) per test were used for aldehyde experiments and controls in order to compare the bed bug attraction to combinations of Hexenal and Octenal. For this experiment, mixtures of Hexenal and Octenal were diluted in silicone oil at the following ratios: 100:0; 75:25; 50:50; 25:75; and 0:100. Each test treatment contained about 30 ppm of the test chemical(s), 5 microliters of the test treatment was applied to the experimental filter paper disk and five microliters of silicone oil only was applied to the control filter paper disks. Readings were taken hourly for four hours from the release of bed bugs in the assay arena. The number of bed bugs under the control disk and the number of bed bugs under the experimental disk were recorded. The test treatment was considered to be an attractant if the number of bed bugs under the experimental filter disk was greater than the number under the control disk. Table 2 below summarizes the experimental data, the experimental test treatments considered as attractants are in bold.

TABLE 2
Bed Bug Attraction to Mixtures of Hexenal and Octenal
(Average of Two Tests)

| Treatment | 1 Hour | | 2 Hour | | | | | |
|---|---|---|---|---|---|---|---|---|
| *H:O | Con- | | Con- | | 3 Hour | | 4 Hours | |
| Ratio | trol | Exp | trol | Exp | Control | Exp | Control | Exp |
| 100:0 | 6 | 3 | 6.5 | 3 | 5.5 | 4.5 | 5 | 5 |
| 75:25 | 1 | 9 | 0.5 | 9.5 | 0 | 9.5 | 0 | 10 |
| 50:50 | 4.5 | 5 | 0.5 | 7.5 | 2 | 7 | 2.5 | 3.5 |
| 25:75 | 1 | 6 | 0.5 | 6.5 | 4 | 5.5 | 5 | 5 |
| 0:100 | 1 | 7.5 | 0.5 | 7.5 | 0 | 9 | 0 | 8.5 |

*H is Hexenal (trans-hex-2-en-1-al); O is Octenal (trans-oct-2-en-1-al)
“Exp” is experimental test treatment

Using the aggregation assay as described above, the most bed bugs were attracted to the experimental filter disks which contained either a 75:25 mixture of Hexenal to Octenal or Octenal alone.

### Example 3

### Determination of Bed Bug Aggregation Effect Using Mixtures of Hexenal, Octenal and Butyric Acid

Attraction Assays: In a manner similar to that described in Example 1, ten bed bugs (Cimex lectularius) per test were used for each experimental test treatment and control in order to compare the bed bug attraction of combinations of Hexenal, Octenal and butyric acid. For this test, a mixture of Hexenal and Octenal (75:25 ratio) was diluted in silicone oil to provide about a 120 ppm solution. Butyric acid was dissolved in deionized water to provide about a 100 ppm solution. For each test, 5 microliters of the above test treatments were applied to the experimental filter paper disk, five microliters of silicon oil only was applied to the filter paper disks for the Hexenal/Octenal controls, 5 microliters of deionized water was applied to the filter paper disks for the butyric acid controls and 5 microliters of silicon and 5 microliters of deionized water were applied to the filter paper disks for the combination controls. Readings were taken hourly for four hours from the release of bed bugs in the assay arena. The number of bed bugs under the control disk and the number of bed bugs under the experimental disk were recorded. The test chemical was considered to be an attractant if the number of bed bugs under the experimental filter disk was greater than the number under the control disk. Table 3 below summarizes the experimental data, the experimental test treatment considered as attractants are in bold.

TABLE 3
Bed Bug Attraction to Mixtures of Hexenal, Octenal and Butyric Acid
(Average of Two Tests)

| | 1 Hour | | 2 Hour | | 3 Hour | | | |
|---|---|---|---|---|---|---|---|---|
| | Con- | | Con- | | | Con- | 4 Hours | |
| *Treatment | trol | Exp | trol | Exp | trol | Exp | Control | Exp |
| **H/O | 1 | 4.5 | 1 | 5.5 | 2 | 5 | 2.5 | 6 |
| BA | 1 | 4.5 | 2 | 5.5 | 2 | 4.5 | 2 | 5 |
| BA/H/O | 1.5 | 6 | 1.5 | 6 | 1.5 | 6 | 0.5 | 7 |

*H is Hexenal (trans-hex-2-en-1-al); O is Octenal (trans-oct-2-en-1-al), BA is Butyric acid
**Hexenal/Octenal in a 75/25 ratio, 120 ppm solution
“Exp” is experimental test treatment

Using the aggregation assay as described above, bed bugs are attracted to a mixture of Hexenal and Octenal as well as to butyric acid. However, bed bugs were much more attracted to the experimental filter disks which contained a 75:25 mixture of Hexenal/Octenal with butyric acid.

### Example 4

### Determination of Bed Bug Aggregation Effect Using Mixtures of Hexenal, Octenal, Butyric Acid and Carbon Dioxide

A test arena was constructed from a 60×40×22 cm (L:W:H) polystyrene container. A 60×40 cm piece of filter paper was glued on the bottom to provide a walking surface for the bed bugs. At one end of the test arena, a triangular piece of plastic (16 cm high×25 cm long) was glued to the middle of the side and bottom of the container to create test zones of equal area on either side of the partition. On each side of this partition a piece of Tygon® tubing was inserted through a hole 7 cm above the bottom of each test zone to deliver a control gas to one side of the partition (control zone) and the experimental gas to the other side of the partition (experimental zone). The tubing was positioned to deliver the gases downward into the test zones with each outlet 6 cm above the filter paper glued to the bottom of the container. At the other end of the test arena, a 4 W night light was placed 35 cm above the bottom of the arena and regulated to a 12 hour light:12 hour dark (7 AM On: 7 PM Off) light cycle. Also placed adjacent to the night light was a small fan (Boston, cat#EHSDF) to create a gentle removal of gases from the distal part of the arena. Air released by the experimental and control gases was contained within their partitions and were gently drawn away from the respective air inputs, mixed within the arena and removed by the fan. This created a laminar flow where the bed bugs had opportunity to select either the experimental or control gas. Fifty bed bugs (Cimex lectularius) were entrapped within an inverted 90 mm Petri dish at a position furthest from the control and experimental zones until bed bugs were quiescent. Removal of the Petri dish started the experiment and readings were taken every hour for two hours. Data collected were number of bed bugs in the experimental, control and free arena zones. In addition, gas temperature, relative humidity, air flow rate, and percent CO₂ data were collected. The experimental gas was considered to be an attractant if more bed bugs were in the experimental zone than in the control zone.

Temperature Regulation: Gas temperatures were regulated by sending the gas through 15 meters of Tygon® tubing coiled in a temperature controlled water bath. At 100 ml/min, gases required 6.3 minutes to equilibrate to the desired temperature. Air temperature was monitored with a high/low thermometer.

Relative Humidity: Air supplies from bottled gases were very dry. To raise the relative humidity, incoming gases (air and CO₂) were passed through an aquarium air stone placed in distilled water (500 ml erlenmeyer flask). A water trap was placed in-line to prevent water from entering the temperature exchange tubing. Relative humidity was monitored using a high/low hygrometer placed in-line immediately before the gas entered the arena. An average relative humidity was controlled from 20% to 70% relative humidity, preferably at about 40% relative humidity.

Air Volume and Test Compositions: Gases were blended and released in controlled amounts. To achieve this Fisher & Porter (Gottingen, Germany) and MG Scientific gas/air gages were calibrated using volume displacement. The relationship between valve settings and air flow was determined and using this information, valve settings were determined that could deliver blended gases (air and CO₂) at a flow rate of about 100 or about 200 ml/min. All gases were pre-conditioned (temperature and relative humidity) prior to mixing. The control gas used for these experiments consisted of house compressed air. The carbon dioxide test gases were prepared by blending compressed house air with either 5% or 100% bottled CO₂. An aqueous solution containing about 300 ppm of Hexenal and Octenal, 75:25 ratio of Hexenal to Octenal, was prepared by dissolving the aldehydes in deionized water. Similarly, an aqueous solution containing about 200 ppm of butyric acid was prepared in deionized water. One 100 micro liter pipette (Drummond Wiretrol 100 μL) was filled with the aldehyde solution and one 100 micro liter pipette was filled with the butyric acid solution. One end of each micro liter pipette was sealed with parafilm leaving one end of each open. The filled pipettes were affixed inside a plastic container which had an air inlet fitting on one side and an air outlet fitting on the opposite side. An air tight lid was placed onto the plastic container and the container was installed in-line after humidity and temperature conditioning of the gas and before the gas entered the arena. The micro liter pipettes were weighed before and after use to determine the amount of aldehyde and acid released. Table 4 below summarizes the data collected from this experiment.

TABLE 4
Bed Bug Attraction to Gaseous Mixtures of Hexenal, Octenal,
Butyric Acid and Carbon Dioxide After Two Hour Exposure

| | | % Bed bugs in | |
|---|---|---|---|
| Test Gas | Temperature of | Experimental | % Bed bugs in |
| Composition | Test Gas ° C. | Zone | Control Zone |
| CO₂ (50% | 23 | 76.0 | 0 |
| concentration) | | | |
| *Hexenal, | 26 | 82.0 | 6.0 |
| Octenal, Butyric | | | |
| Acid | | | |
| **Hexenal, | 24 | 93.8 | 0 |
| Octenal, Butyric | | | |
| Acid, CO₂ | | | |

*Hexenal/Octenal in a 75/25 ratio at a concentration of 73 nanograms/hour @ 100 mL/min air flow; butyric acid at a concentration of 3.097 micrograms/hour @ 100 ml/min air flow.
**Hexenal/Octenal in a 75/25 ratio at a concentration of 73 nanograms/hour @ 100 mL/min air flow; butyric acid at a concentration of 3.097 micrograms/hour @ 100 ml/min air flow and CO₂ @ 50% concentration.

As can be seen from the test arena assay as described above, bed bugs are attracted to a gaseous mixture of Hexenal, Octenal and butyric acid; however the bed bugs were much more attracted to the experimental gases with the addition of carbon dioxide.

### Example 5

### Determination of Bed Bug Aggregation Effect Using Hexenal, Butyric Acid, trans-2-Hexen-1-al Diethylacetal, Trimethylsilyl Butyrate or Methyl Butyrate Dissolved in an Alkane Solvent Using the test arena and methods described in Example 4, test treatments containing about 300 ppm of a pro-aldehyde compound, trans-2-hexen-1-al diethylacetal, dissolved in nonane, about 300 ppm of Hexenal dissolved in nonane, about 200 ppm of butyric acid dissolved in nonane and about 200 ppm of a pro-organic acid compound, trimethylsilyl butyrate or methyl butyrate, dissolved in nonane were prepared. Separate 100 micro liter pipettes (Drummond Wiretrol 100 μL) were filled with the test solutions. One end of each micro liter pipette was sealed with parafilm leaving one end of each open. The filled pipettes were affixed inside a plastic container which had an air inlet fitting on one side and an air outlet fitting on the opposite side. An air tight lid was placed onto the plastic container and the container was installed in-line after humidity and temperature conditioning of the gas and before the gas entered the arena. The micro liter pipettes were weighed before and after use to determine the amount of the test compounds released. The control gas used for these experiments consisted of house compressed air. Table 5 below summarizes the data collected from this experiment.

TABLE 5
Bed Bug Attraction to Gaseous Mixtures of trans-2-hexen-1-al
diethylacetal or methyl butyrate After Two Hour Exposure

| | | % Bed bugs in | |
|---|---|---|---|
| *Test Gas | Temperature of | Experimental | % Bed bugs in |
| Composition | Test Gas ° C. | Zone | Control Zone |
| trans-2-hexen-1- | 22 | 28.0 | 10.0 |
| al diethylacetal | | | |
| Trimethylsilyl | 21 | 9 | 16 |
| butyrate | | | |
| methyl butyrate | 21 | 34.0 | 24.0 |
| Hexenal | 21 | 38.0 | 22.0 |
| Butyric acid | 21 | 34.0 | 24.0 |

*trans-2-Hexen-1-al diethylacetal at a concentration of 184.8 nanograms/hour @ 100 mL/min air flow.
Trimethylsilyl butyrate at a concentration of 182.0 nanograms/hour@100 mL/min air flow.
Methyl butyrate at a concentration of 150.0 nanograms/hour @ 100 mL/min air flow.
Hexenal at a concentration of 180.0 nanograms/hour @ 100 mL/min air flow.
Butyric acid at a concentration of 150.0 nanograms/hour @ 100 mL/min air flow.

As can be seen from the test arena assay as described above, bed bugs are attracted to a gaseous mixture that contains trans-2-hexen-1-al diethylacetal, trimethylsilyl butyrate, methyl butyrate, Hexenal or butyric acid. Bed bugs are most attracted to a gaseous mixture that contains trans-2-hexen-1-al diethylacetal, methyl butyrate, Hexenal or butyric acid than to a control gas containing no aldehyde or organic acid compounds.

### Example 6

### Determination of Bed Bug Aggregation Effect Using Mixtures of Hexenal, Octenal and Butyric Acid Dissolved in Alkane Solvents

A test arena was constructed from a 60×40×22 cm (L:W:H) polystyrene container. A 60×40 cm piece of filter paper was glued on the bottom to provide a walking surface for the bed bugs. At one end of the test arena, a triangular piece of plastic (16 cm high×25 cm long) was glued to the middle of the side and bottom of the container to create test zones of equal area on either side of the partition. Traps were placed in both the control and the experimental zones.

The control zone trap did not contain any lure, while the experimental zone trap contained two one hundred micro Liter pipettes. One end of each pipette (Drummond Wiretrol 100 μL) was sealed with parafilm while the other end was left open. The first pipette contained about a 300 ppm solution containing Hexenal and Octenal in a 75:25 ratio, prepared by dissolving the aldehydes in decane. The second pipette contained about a 200 ppm solution of butyric acid in nonane.

Fifty bed bugs (Cimex lectularius) were entrapped within an inverted 90 mm Petri dish at a position furthest from the control and experimental zones until the bed bugs were quiescent. Removal of the Petri dish started the experiment. After 2 hours it was observed that 20-30 bed bugs were located within 5-15 cm of the test zone trap, but that no bed bugs were closer than 5 cm to the trap. This observation supports the conclusion that these attractants will effectively attract bed bugs at a given concentration, but will repel them if present at too high a concentration.

Those of ordinary skill in the art will appreciate that variations of the invention may be used and that it is intended that the invention may be practiced otherwise than as specifically described herein. Accordingly, this invention includes all modifications encompassed within the spirit and scope of the invention as defined by the following claims.

What is claimed is:

1. A method for attracting bed bugs to a desired location comprising locating an attractant composition consisting essentially of:
an unsaturated aldehyde component and
an organic acid component,
in the desired location.

2. The method of claim 1, wherein the unsaturated aldehyde component is comprised of one or more aldehydes selected from the group consisting of trans-2-hexen-1-al and trans-2-octen-1-al.

3. The method of claim 2, wherein the aldehyde is trans-2-hexen-1-al.

4. The method of claim 2, wherein the aldehyde is trans-2-octen-1-al.

5. The method of claim 2, wherein the aldehyde component is trans-2-hexen-1-al and trans-2-octen-1-al in a weight to weight ratio of from about 1:5 to about 5:1.

6. The method of claim 1, wherein the organic acid is butyric acid.

7. The method of claim 1, wherein the unsaturated aldehyde component is comprised of one or more aldehydes selected from the group consisting of trans-2-hexen-1-al and trans-2-octen-1-al and the organic acid is butyric acid.

8. The method of claim 7, wherein the unsaturated aldehyde and the organic acid component are dissolved in an organic solvent.

9. The method of claim 8, wherein the attractant composition is located in, on or near a bed bug control device.

10. A method of attracting bed bugs to a location by volatilizing a bed bug attractant composition comprising an unsaturated aldehyde component and an organic acid component in the location.

11. The method of claim 10 wherein the unsaturated aldehyde component is comprised of one or more aldehydes selected from the group consisting of trans-2-hexen-1-al and trans-2-octen-1-al and the organic acid is butyric acid.

12. The method of claim 10 further comprising adding carbon dioxide to the volatilized composition.

13. A method of attracting bed bugs to a location by volatilizing a bed bug attractant composition consisting essentially of an unsaturated aldehyde component and an organic acid component in the location.

14. The method of claim 13 wherein the unsaturated aldehyde component is comprised of one or more aldehydes selected from the group consisting of trans-2-hexen-1-al and trans-2-octen-1-al and the organic acid is butyric acid.

15. The method of claim 13 further comprising adding carbon dioxide to the volatilized composition.

16. A bed bug attractant composition comprising:
an unsaturated aldehyde component and
an organic acid component.

17. The composition of claim 16, wherein the unsaturated aldehyde component consists of one or more aldehydes selected from the group consisting of trans-2-hexen-1-al and trans-2-octen-1-al.

18. The composition of claim 17, wherein the aldehyde is trans-2-hexen-1-al.

19. The composition of claim 17, wherein the aldehyde is trans-2-octen-1-al.

20. The composition of claim 17, wherein the aldehyde component is trans-2-hexen-1-al and trans-2-octen-1-al in a weight to weight ratio of from about 1:5 to about 5:1.

21. The composition of claim 16, wherein the organic acid is butyric acid.

22. A bed bug attractant composition consisting essentially of:
an unsaturated aldehyde component and
an organic acid component.

23. The composition of claim 22, wherein the unsaturated aldehyde component consists of one or more aldehydes selected from the group consisting of trans-2-hexen-1-al and trans-2-octen-1-al.

24. The composition of claim 23, wherein the aldehyde is trans-2-hexen-1-al.

25. The composition of claim 23, wherein the aldehyde is trans-2-octen-1-al.

26. The composition of claim 23, wherein the aldehyde component is trans-2-hexen-1-al and trans-2-octen-1-al in a weight to weight ratio of from about 1:5 to about 5:1.

27. The composition of claim 22, wherein the organic acid is butyric acid.

28. The composition of claim 16, wherein the unsaturated aldehyde component is a pro-aldehyde compound.

29. The composition of claim 16, wherein the organic acid component is a pro-organic acid compound.

30. The composition of claim 22, further including carbon dioxide.
